(19) United States
(12) Patent Application Publication
(10) Pub. No.: US 2010/0109500 A1
(43) Pub. Date: May 6, 2010

(54) LIGHT GENERATING UNIT

(76) Inventors: HSUEH-CHUNG KAO, Tainan City (TW); Chao-Jen Wang, Tainan Hsien (TW)

Correspondence Address: LEONG C LEI, PMB # 1008, 1867 YGNACIO VALLEY ROAD, WALNUT CREEK, CA, 94598, US

(21) Appl. No.: 12/611,885

(22) Filed: Nov. 3, 2009

(30) Foreign Application Priority Data
Nov. 5, 2008 (TW) 097142634

(51) Int. Cl. H01J 61/52

(52) U.S. Cl. 313/46

(57) ABSTRACT

A light generating unit is provided herein which contains a light generating member using LED, a heat dissipating member, and a transparent reflective member. The light generating member is configured on the heat dissipating member and the transparent reflective member is configured in front of the light generating member. Inside the transparent reflective member and opposing the light generating member, a transparent reflective element is provided. Light projected into the transparent reflective member is thereby reflected and diffused. A second light emitting body could be provided in front of the transparent reflective member to increase the light coverage angle and area, and to increase the dazzling effect.

### TECHNICAL FIELD OF THE INVENTION

The present invention generally relates to a light generating unit, and more particularly relates to a light generating unit that projects light from a light generating member using LED into a highly transmittal transparent reflective member or a second light emitting body to enlarge coverage area and to create dazzling effect.

### DESCRIPTION OF THE PRIOR ART

In daily life, there are various light generating units for atmospheric creation such as tungsten light bulbs, mercury-containing spiral or multi-U shaped electronic energy saving light tubes, etc. Each type of light generating unit has a specific light pattern and is applied in appropriate lighting devices. For example, to create soft and uniform light atmosphere, usually energy saving light tubes of various shapes are used. Alternatively, tungsten light bulbs could have its exterior roughened to create a matt diffusing layer so that light is uniformly projected and, when viewed directly, it is not harsh to the eye. On the other hand, to be used in a chandelier or to create a concentrated light pattern such as candle or kerosene lamp, usually high-power, conventional, quartz-based, or gas-filled tungsten light generating units are required. However, as energy saving and environmental protection has become mainstream, the forgoing light generating units shall soon be replaced in the near future.

FIG. 1 shows a conventional light generating unit which has already been popular for over a hundred years but also has the worst electricity-to-light conversion efficiency. As illustrated, the light generating unit 8 contains an electrical contact member 81, a conducting frame 82, a tungsten filament 83, and a glass cover 84. The tungsten filament 83 is supported by the conducting frame 82 in the center of the glass cover 84. When the tungsten filament 83 is excited by electrical energy to produce light energy, light is projected omni-directionally through the glass cover 84. As the glass cover 84 is transparent, viewer could directly see the shape and rays. Due to its low conversion efficiency, the light generating unit should be totally replaced in the near future.

FIG. 2 shows a conventional light emitting diode (LED) light bulb 9, which contains an electrical contact 91, a power element 92, a LED element 93, and a matt cover 94. The LED element 93, due to its waste heat, has to be configured with assemblies capable of heat dissipation. It therefore cannot produce omni-directional coverage such as the tungsten light bulb. When the LED element 93 projects light forward, a portion of the light energy would directly penetrate the matt cover 94 while the other portion would be kept inside the matt cover and undergoes repeated reflections and penetrations. In the process, a lot of light energy is absorbed and wasted. The light generating unit therefore cannot achieve true energy saving.

LED is the most promising candidate for future light generation. However, its being highly directional and concentrated makes it difficult to be utilized in atmospheric creation and landscape applications. In these areas, LED-based light generating units still cannot replace conventional light generating units. A motivation of the present inventor is to provide a novel LED-based light generating unit to overcome the foregoing drawbacks.

### SUMMARY OF THE INVENTION

A major objective of the present invention is to provide a light generating unit to replace conventional light bulbs. The gist of the present invention lies in that a transparent reflective member is configured in front of a light generating member so that the direction of light is altered to enlarge the coverage angle of light emitting diode and to create significant dazzling effect.

To achieve the objective, the light generating member using LED is configured on a heat dissipating member and the transparent reflective member is configured in front of the light generating member. Light produced by the light generating member therefore is projected into the transparent reflective member. The transparent reflective member is made of a highly transmittal material with embedded light diffusing particles. Inside the transparent reflective member and opposing the light generating member, a transparent reflective element is provided. As such, light energy produced by the light generating member, through the high transmittance of the transparent reflective member and the function of the transparent reflective element, is thereby reflected and diffused to create reflected light and light spot effect. Therefore, when viewed directly from beneath the transparent reflective member, an illusion that the transparent reflective member is the light source is created. The present invention could also reflect a portion of light to the back of the light generating member so that the invention could be more flexibly applied. The present invention could be utilized in any lighting device, indeed possessing novelty, non-obviousness, and practicality.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram of a conventional light generating unit.

FIG. 2 is a schematic diagram of another conventional light generating unit.

FIG. 3 is a perspective breakdown diagram showing the various components of a light generating unit according to an embodiment of the present invention.

FIGS. 4A and 4B are schematic diagrams showing two embodiments of the transparent reflective member of the present invention.

FIGS. 5A and 5B are schematic diagrams showing another two embodiments of the transparent reflective member of the present invention.

FIG. 6 is a schematic diagram showing yet another embodiment of the transparent reflective member of the present invention.

FIG. 6A is an enlarged view of the portion C of FIG. 6.

FIG. 6B is an enlarged view of the portion D of FIG. 6.

FIG. 7 is a schematic diagram showing an embodiment of the present invention with a second light emitting body.

FIG. 8 is a schematic diagram showing another embodiment of the present invention with a second light emitting body.

FIG. 8A is an enlarged view of the portion B of FIG. 8.

FIG. 9 is a schematic diagram showing yet another embodiment of the present invention with a second light emitting body.

FIG. 9A is an enlarged view of the portion A of FIG. 9.

FIG. 10 is a schematic diagram showing still another embodiment of the present invention with a second light emitting body.

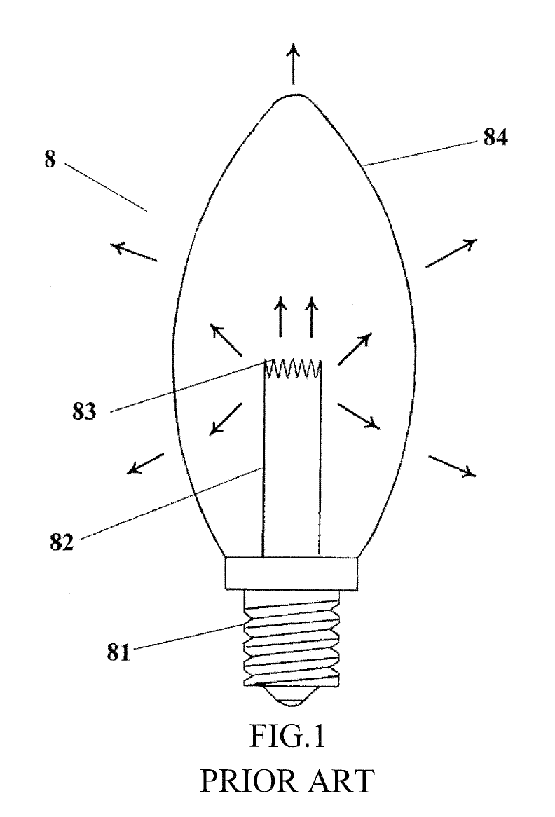

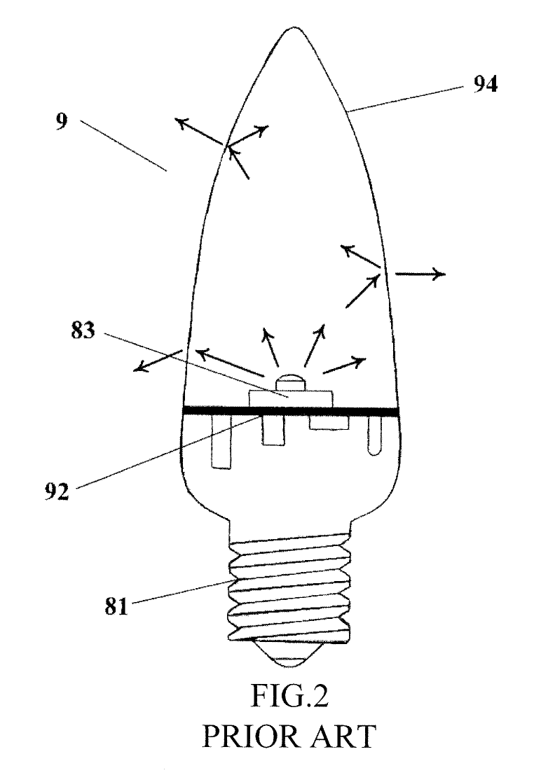

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

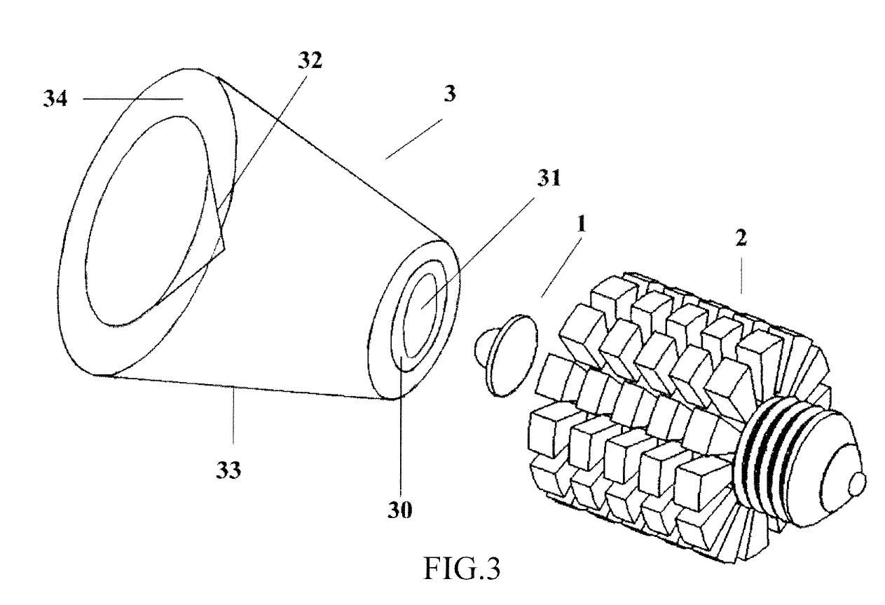

As shown in FIG. 3, a light generating unit according to an embodiment of the present invention contains a light emitting diode (LED) light generating member 1, a heat dissipating member 2, and a transparent reflective member 3.

There could be one or more LED light generating members 1 arranged in the light generating unit and they are aggregated so that their emitted light is focused towards a light incident element 31 of the transparent reflective member 3.

The heat dissipating member 2 is an assembly where the light generating member 1 is installed for the dissipation of the heat produced by the light generating member 1. The heat dissipating member 2 could also be used for the installation of power rectifier and electrical terminals.

The transparent reflective member 3 has a connection element 30 at an end for fixedly joining the transparent reflective member 3 with the heat dissipating member 2 so that the transparent reflective member 3 is positioned in front of the light generating member 1. The transparent reflective member 3 is made of transparent, highly light-transmittal material embedded with light diffusing particles. The light incident element 31 is at an end for receiving the light energy from the light generating member 1. At an opposite end to the light incident element 31, a transparent reflective element 32 capable of reflecting a portion of light is provided. Most light energy runs through the transparent reflective element 32 and a front emitting element 34, and departs the transparent reflective member 3. On the other hand, a portion of light energy is reflected to and penetrates through a lateral emitting element 33 of the transparent reflective member 3.

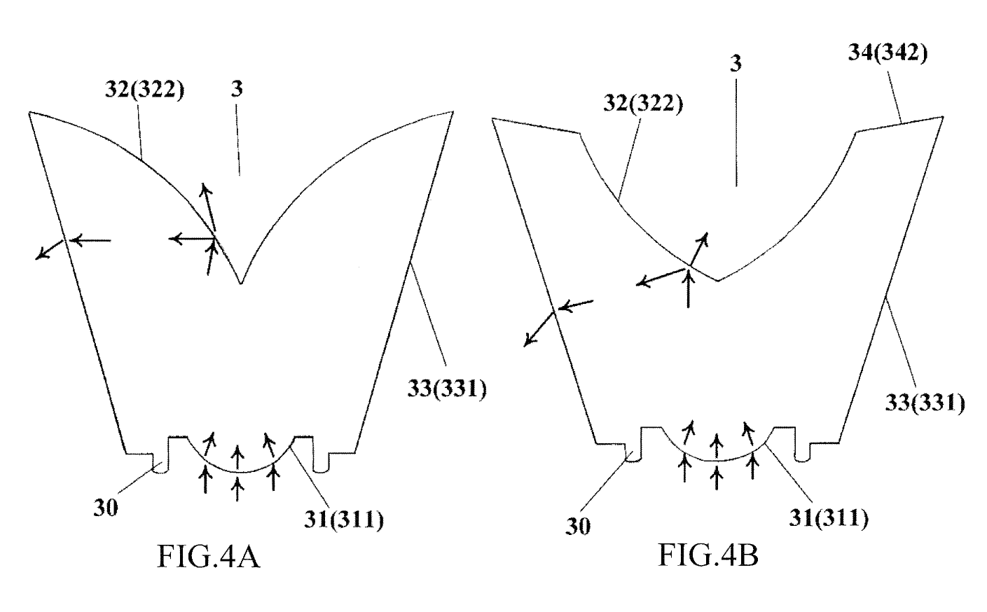

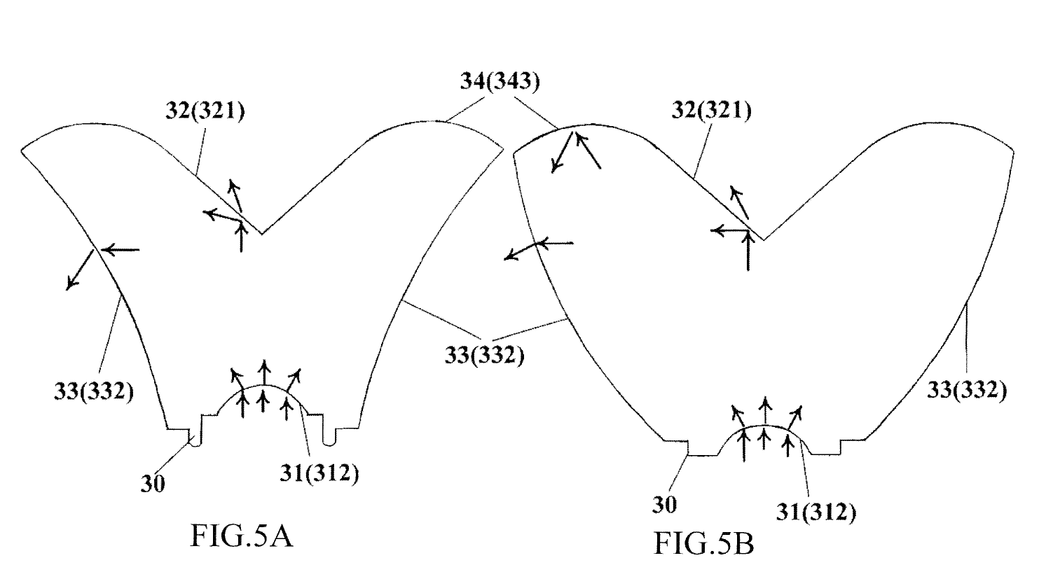

As shown in FIGS. 4A, 4B, 5A and 5B, light energy produced by the light generating member 1 is focused towards and penetrates the light incident element 31, and enters the transparent reflective member 3. According to the geometric property of the light incident element 31, light is refracted towards various directions. In other words, depending on its shape, the light incident element 31 is able to collimate, diffuse, or focus light. As shown in FIGS. 4A and 4B, the light incident element 31 has a outwardly convex incident face 311 while, in as shown in FIGS. 5A and 5B, the light incident element 31 has an inwardly concave incident face 312. As such, the light energy distribution and angle over the transparent reflective element 32 could be varied. The transparent reflective element 32 in turn, with its geometric shape and angle, reflects the light energy refracted by the light incident element 31 so that a portion is directed towards the lateral emitting element 33. As shown in FIGS. 4A and 4B, the transparent reflective element 32 exhibits outwardly and inwardly curved faces 322, respectively. On the other hand, as shown in FIGS. 5A and 5B, the transparent reflective element 32 exhibits slant flat faces 321. In addition, in order to effectively guide the reflected light outside the lateral emitting element 33 towards pre-determined directions and to form light patterns, the lateral emitting element 33 could also be shaped differently. As shown in FIGS. 4A and 4B, the lateral emitting element 33 exhibits slant plant faces 331 while, as shown in FIGS. 5A and 5B, the lateral emitting element 33 exhibits inwardly and outwardly curved faces 332. In the latter case, the lateral emitting element 33 is able to direct and distribute light towards the back of the light generating member 1. As to the front emitting element 34, it is reduced to a line as shown in FIG. 4A while, in FIG. 4B, it has a slant flat face 342 and, in FIGS. 5A and B, it has curved faces 343 of different curvatures, respectively.

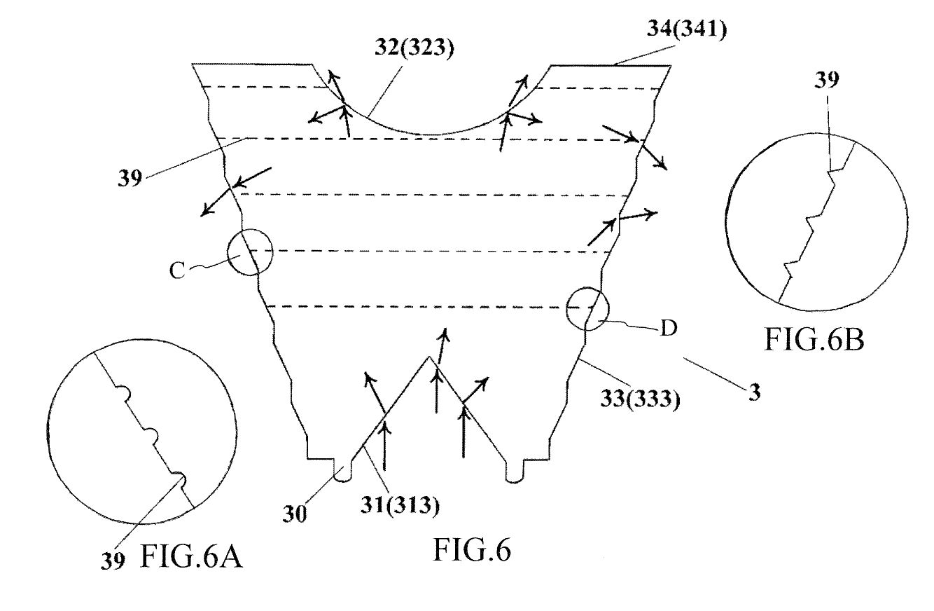

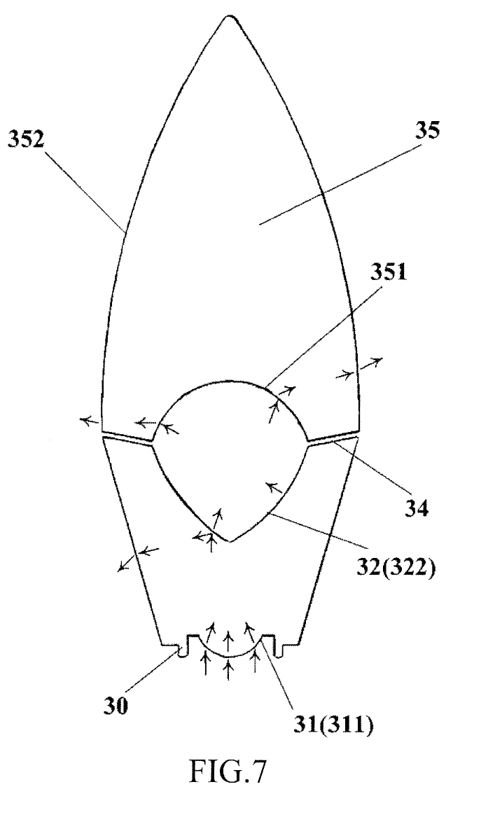

As shown in FIGS. 6, 6A and 6B, in order to control the light energy distribution and angle to the sides and to the back, the various structures of the transparent reflective member 3 could be designed accordingly. For example, to achieve that light flux is uniformly distributed to the back and to the side, the slope and shape of the slant light incident face 313 of the light incident member 31 and the curved face 323 of the transparent reflective element 32 could be appropriately configured. In addition, the slope and shape of the lateral emitting element 33 could be designed to have a ripple face 333 so as to control the reflection portion and the direction and angle of reflected light. Further more, on all the surfaces of the transparent reflective member 3, triangular or curved grooves 39 could be configured. As light passes through these grooves 39, as the refraction angles intersect, light energy is partially overlapped, creating an effect like the sun light shining on rippled water surface and creating ripple-like light pattern at the bottom of the water. As shown in FIG. 7, the light incident element 31 has an outwardly convex light incident face 311. As such, the light from the light generating member 1 is focused on the slant curved faces 322 of the transparent reflective element 32. Most of the light energy would penetrate the slant curved faces 322 and produce significant light reflection on the transparent reflective element 32. A light pattern similar to the candle flame is thereby produced. To achieve more appealing pattern or more light energy to the sides, a second light emitting body 35 could be provided. The light energy out of the transparent reflective element 32 and the front emitting element 34 are again refracted by the geometric structure of a second light incident element 351 and directed to a second lateral emitting element 352 and then out of the second light emitting body 35 to the lateral sides from there.

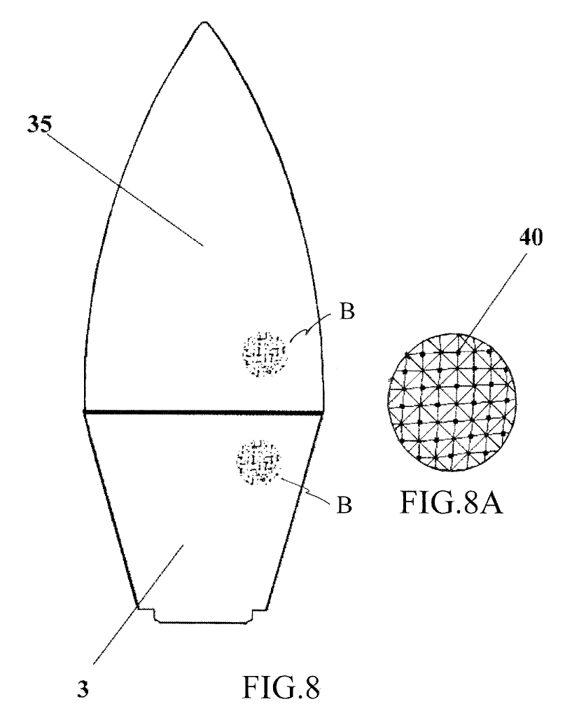

As shown in FIGS. 8 and 8A, in order to create lighting effects similar to those of a chandelier, all light emitting surfaces of the transparent reflective member 3 and the second light emitting body 35 could have various structures. As illustrated, on the slant flat face 331 and the second lateral emitting element 352, continuous cone-shaped structures 40 are provided. As the cone structure 40 provides intersecting refraction angles, light energy therefore would be overlapped and creates various variations to the light pattern.

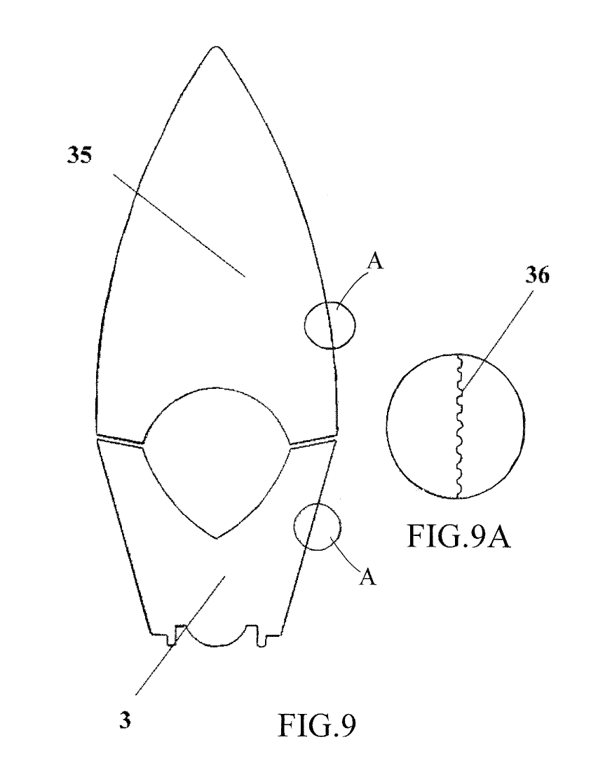

As shown in FIGS. 9 and 9A, in order to create soft, smooth, and soothing atmosphere, all light emitting surfaces of the transparent reflective member 3 and the second light emitting body 35 could be further roughened. As illustrated, on the slant flat face 331 and the second lateral emitting element 352, light diffusing particles 36 are provided so as to scatter the light to achieve uniform light pattern.

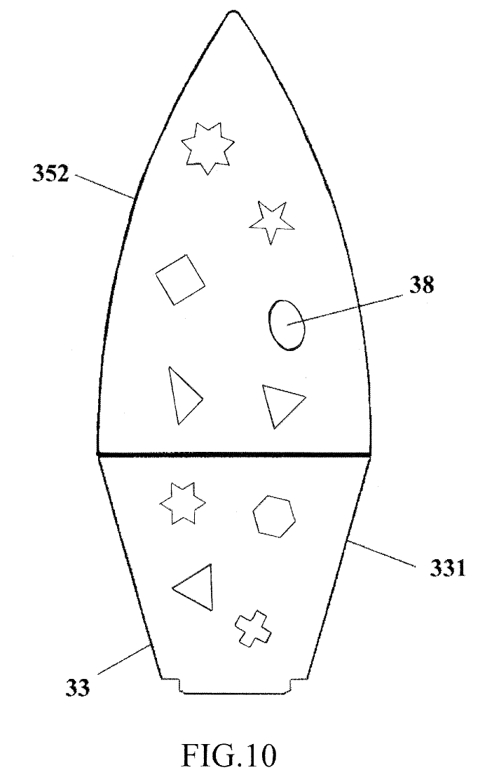

As shown in FIG. 10, in order to create even more appealing lighting effect, all light emitting surfaces of the transparent reflective member 3 and the second light emitting body 35 could be further configured with various colorful shapes. As illustrated, on the slant flat face 331 and the second lateral emitting element 352, shapes 38 are provided so as to be projected to the environment to achieve appealing lighting effect.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light generating unit, comprising:
one or more LED light generating member arranged in said light generating unit and aggregated so that their light are focused in a area;
a heat dissipating member for the installation of said light generating member and for the dissipation of the heat produced by said light generating member;
a transparent reflective member joined with said heat dissipating element in front of said light generating member, said transparent reflective member having a light incident element for receiving incident light, a transparent reflective element opposite to said light incident element for reflecting light towards the sides and the back, a lateral emitting element through which light is projected to the sides and the back, and a front emitting element where light is projected to the front.

2. The light generating unit according to claim 1, wherein said transparent reflective element has one of a circular curved face, slant curved face, conic face, polygonal slant face, and polygonal curved face.

3. The light generating unit according to claim 1, wherein said lateral emitting element has one of a circular curved face, slant curved face, conic face, polygonal slant face, and polygonal curved face.

4. The light generating unit according to claim 1, wherein said light incident element has one of an outwardly convex face, an inward concave face, a slant face, a slant curved face, and a flat face.

5. The light generating unit according to claim 1, further comprising a second light emitting body in front of said transparent reflective member.

6. The light generating unit according to claim 1, wherein said transparent reflective member is made of a highly transmittal material embedded with light diffusing particles.

7. The light generating unit according to claim 1, wherein said second light emitting body, and said transparent reflective element, said front emitting element, said lateral emitting element of said transparent reflective member have light scattering microstructures.

8. The light generating unit according to claim 1, wherein said second light emitting body, and said transparent reflective element, said front emitting element, said lateral emitting element of said transparent reflective member have colors.

9. The light generating unit according to claim 1, wherein said transparent reflective element, said front emitting element, said lateral emitting element of said transparent reflective member have light projecting shapes.

10. The light generating unit according to claim 1, wherein said second light emitting body, and said front emitting element, said lateral emitting element of said transparent reflective member have ripple structures.

11. The light generating unit according to claim 1, wherein said second light emitting body, and said transparent reflective element, said front emitting element, said lateral emitting element of said transparent reflective member have plural conic structures.
